(19) United States
(12) Patent Application Publication
(10) Pub. No.: US 2025/0233912 A1
(43) Pub. Date: Jul. 17, 2025

(54) Method for Transmitting and Receiving Information Using the Automatic Identification System

(71) Applicant: The United States of America, as represented by the Secretary of the Navy, Arlingtion, VA (US)

(72) Inventors: Doug Kenneth Herbers, San Diego, CA (US); Vladimir Y. Matveyev, Carlsbad, CA (US); Gregory Knowles Fleizach, San Diego, CA (US); Lynne A. Tablewski, San Diego, CA (US); Barry R. Hunt, San Diego, CA (US)

(21) Appl. No.: 18/413,387

(22) Filed: Jan. 16, 2024

(51) Int. Cl. H04L 67/12; H04B 7/185

(52) U.S. Cl. CPC H04L 67/12; H04B 7/1851

(57) ABSTRACT

A method for transmitting information comprising: receiving sensor data from a passive sensor mounted to a first platform; using a first computer mounted on the first platform to encode the sensor data into a binary code that fits within a message field of an AIS transmission associated with the first platform; transmitting the AIS transmission that includes the binary code to a second platform; using a second computer to decode the sensor data from the binary code in the AIS transmission from the first platform; and displaying the first platform's AIS information along with the decoded sensor data.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 211118.

### BACKGROUND OF THE INVENTION

There is a wide array of remote sensors being developed and deployed around the world to collect data. As the price of the sensors comes down through increased production, one constant is the cost of the data transfer from the sensor to the operator. Many current sensors rely on satellite communication networks such as Iridium to transfer data from remote sensors. Due to the design of these satellite communication systems and the limited availability of bandwidth and downlinks, the collected data sometimes has a significant latency, which reduces the usability of the data to the operator. Moreover, the system design is constrained by the antenna and power requirements of the remote link. There is a need for an improved method of transferring data.

### SUMMARY

Described herein is an embodiment of a method for transmitting information comprising the following steps. The first step provides for receiving sensor data from a passive sensor mounted to a first platform. Another step provides for using a first computer mounted on the first platform to encode the sensor data into a binary code that fits within a message field of an automatic identification system (AIS) transmission associated with the first platform. Another step provides for transmitting the AIS transmission that includes the binary code to a second platform. Another step provides for using a second computer to decode the sensor data from the binary code in the AIS transmission from the first platform. Another step provides for displaying the first platform's AIS information along with the decoded sensor data.

Also described herein is another embodiment of the method for transmitting information that comprises the following steps. The first step provides for receiving a given AIS transmission associated with a given platform with a sensor mounted to a first platform. Another step provides for encoding the given AIS transmission into a binary code that fits within a message field of a first AIS transmission associated with the first platform. Another step provides for transmitting the first AIS transmission that includes the binary code to a second platform. Another step provides for decoding the given AIS transmission from the binary code. Another step provides for displaying AIS details of both the first and given platforms.

### BRIEF DESCRIPTION OF THE DRAWINGS

Throughout the several views, like elements are referenced using like references. The elements in the figures are not drawn to scale and some dimensions are exaggerated for clarity.

FIG. 1 is a flowchart of a method for transmitting information.

FIG. 2 is an illustration of an example system that may be used to implement an embodiment of a method for transmitting information.

FIG. 3 is an illustration of an example environment where an embodiment of a method for transmitting information may be used.

FIG. 4 is a flowchart of a method for transmitting information.

FIG. 5 is an illustration of an operational view of the architecture of an embodiment of a method for transmitting information.

### DETAILED DESCRIPTION OF EMBODIMENTS

The disclosed method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

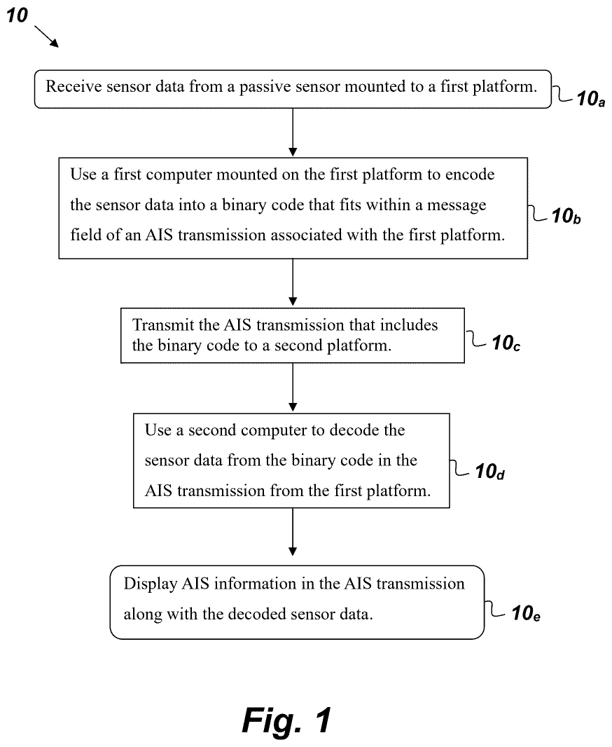

FIG. 1 is a flowchart of an embodiment of a method 10 for transmitting and receiving information using AIS that comprises, consists of, or consists essentially of the following steps. The first step 10ₐ provides for receiving sensor data from a passive sensor mounted to a first platform. Another step 10_{b} provides for using a first computer mounted on the first platform to encode the sensor data into a binary code that fits within a message field of an AIS transmission associated with the first platform. Another step 10_{c} provides for transmitting the AIS transmission that includes the binary code to a second platform. Another step 10_{d} provides for using a second computer at the second platform to decode the sensor data from the binary code in the AIS transmission from the first platform. Another step 10ₑ provides for displaying AIS information in the AIS transmission along with the decoded sensor data.

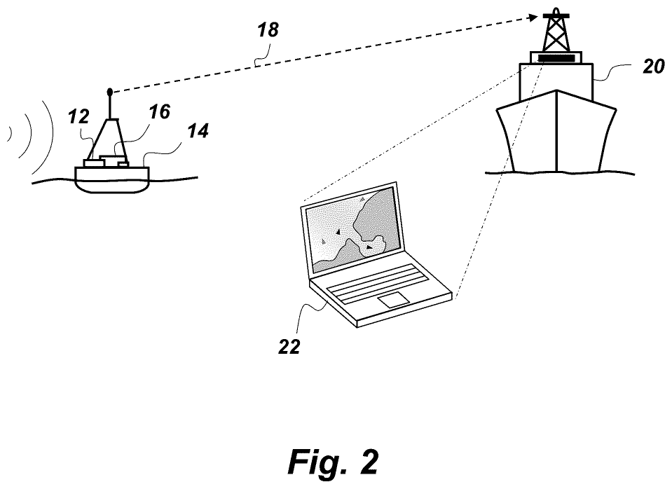

FIG. 2 is an illustration of an example system that may be used to implement an embodiment of method 10. In FIG. 2, a passive sensor 12 is mounted to a first platform 14. Suitable examples of the passive senor 12 include, but are not limited to, a camera, a SONAR sensor, a RADAR sensor, a temperature sensor, a wind sensor, a microphone, an RF receiver, and an optical sensor. Suitable examples of the first platform 14 include, but are not limited to, a ship, boat, buoy, sub-surface vessel, shore facility, and aircraft. A first computer 16 is communicatively coupled to the passive sensor 12 and mounted on the first platform 14. The first computer 16 may be any processor or logic circuit capable of encoding the sensor data into a binary code that fits within a message field of a first AIS transmission 18, which contains AIS information associated with the first platform 14. The first AIS transmission 18 that includes the binary code can then be transmitted to a second platform 20 that may be on an ocean surface, below an ocean surface, in the air, on the land, underground, or in space. Suitable examples of the second platform 20 include, but are not limited to, a satellite in low-earth orbit, a shore facility, a ship, a buoy, and a lighter-than-air vehicle. Once the first AIS transmission 18 has been received at the second platform 20, a second computer 22 may be used to decode and display the sensor data from the binary code in the first AIS transmission 18.

Method 10 may be used to transfer electronic data over AIS channels—either to a vessel or shore location in the immediate area of the sensor or to a ship or shore location thousands of miles from the sensor. The characteristics of the data collection may be encoded using the AIS message standards, transmitted via the standard VHF frequency, then received and decoded in order to provide additional information in near-real time to worldwide users. Method 10 may be used with nearly any shore or floating platform including, but not limited to, unmanned surface vehicles (USVs), manned vessels, buoys, and land-based electronic data collection sites. The data that could be transferred using this method could be, for example, acoustic collections, or even hydrographic/environmental sensing data. The proliferation of low-cost, commercially-available underwater network of hydrophones and associated ancillaries means that line-of-bearing, position and track data are becoming available from a wide range of hydrophone and hydrophone-array assemblies. An example operational scenario may be that patrol vessels are in close enough proximity to the sensing systems to either receive information from the sensors. Such information can then be relayed to shore or other units via an AIS data channel according to method 10.

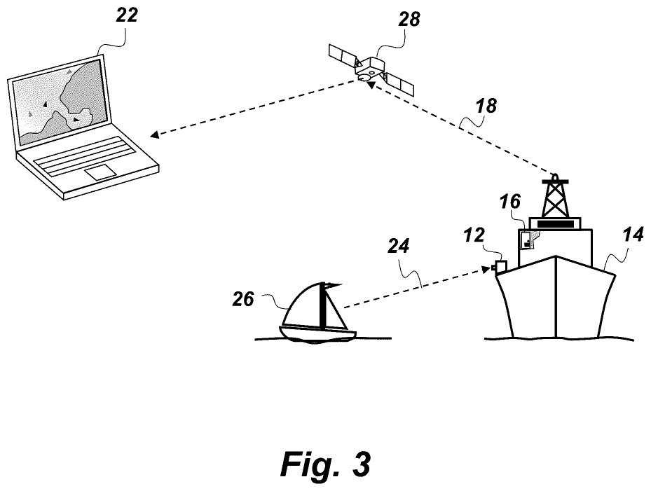

FIG. 3 is an illustration of another example environment where an embodiment of method 10 may be used. In this embodiment of method 10, a low-power AIS transmission 24 (such as may be generated by a class-B AIS transponder) from a given platform 26 is received by the sensor 12, which is mounted to the first platform 14. The first computer 16 may then be used to encode the low-power AIS transmission 24 into a binary code that fits within a message field of the first AIS transmission 18 (such as may be generated by a class-A AIS transponder) that includes AIS information associated with the first platform 14. Thus, the AIS information of two separate platforms (i.e., the given platform 26 and the first platform 14) may be transmitted with a single AIS transmission (i.e., the first AIS transmission 18) to a third platform 28, which in this example environment is a low-earth orbit satellite. From the third platform 28, the first AIS transmission 18 may be relayed to the second computer 22, which may be located anywhere within transmission range of the third platform 28. The second computer 22 may be used to decode the binary code and display the AIS information for both platforms. Method 10 allows a user to receive AIS data pertaining to the given platform 26 even though the third platform 28 may be out-of-range of receiving the low-power AIS transmission 24 directly from the given platform 26. AIS information may include details such as, but not limited to, a unique identification, position, course, and speed for a corresponding platform.

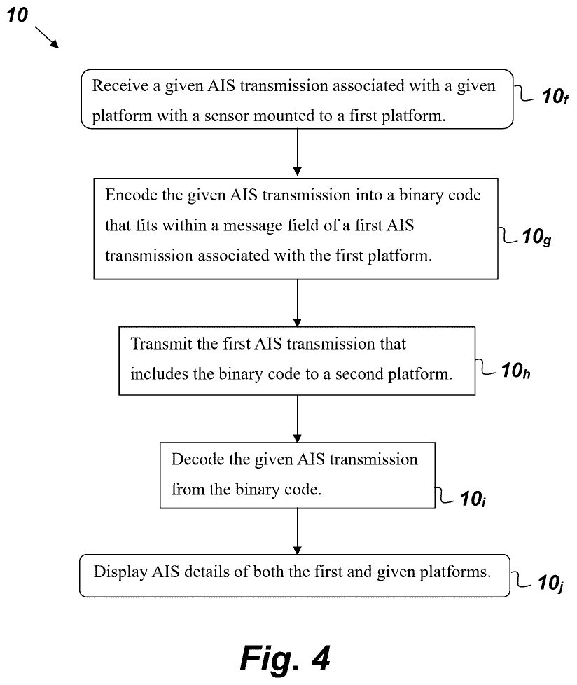

FIG. 4 is a flowchart of an embodiment of method 10 for transmitting and receiving information using AIS that comprises, consists of, or consists essentially of the following steps. The first step 10_{f} provides for receiving a given AIS transmission associated with a given platform with a sensor mounted to a first platform. Another step 10_{g} provides for encoding the given AIS transmission into a binary code that fits within a message field of a first AIS transmission associated with the first platform. Another step 10ₕ provides for transmitting the first AIS transmission that includes the binary code to a second platform. Another step 10ᵢ provides for decoding the given AIS transmission from the binary code. Another step 10ⱼ provides for displaying AIS details of both the first and given platforms.

Method 10 may be used to exfiltrate data via the existent AIS aggregation and reporting backbone. That is, instead of trying to relay local sensor information to other vessels in the line of sight, method 10 utilizes the AIS reporting infrastructure to move the sensor data. This can be done in plain sight or covertly (e.g. with steganography). A mature and comprehensive worldwide network of satellite and terrestrial receivers with distribution backbone already exists that are able to receive the transmitted data without the need for any additional infrastructure investment. The received data would be decoded after the AIS message is received by the intended party and the specific characteristics of the data collection would be decoded into a standard format and routed to the appropriate systems and operators to take action on the information.

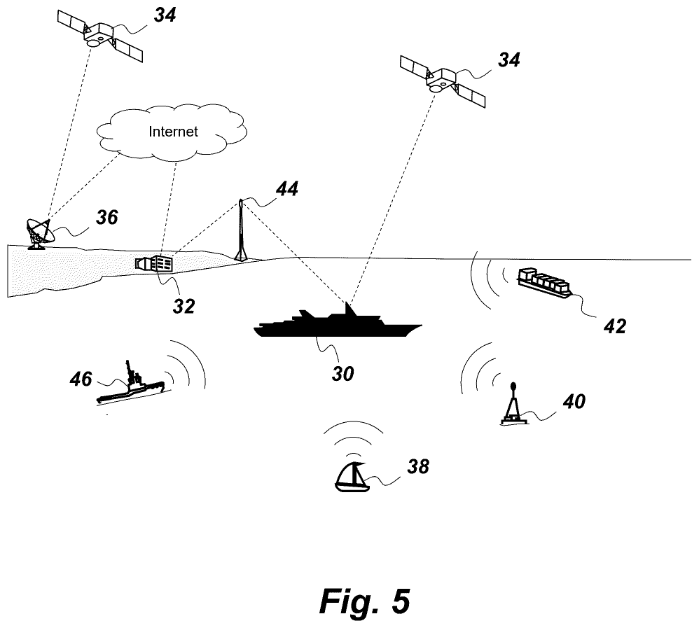

FIG. 5 is an illustration of an operational view of the architecture of an embodiment of method 10 showing a large ship 30, a maritime operations center 32, satellites 34, a satellite ground station 36, a sailboat 38, a buoy 40, a cargo ship 42, terrestrial AIS infrastructure 44, and a small motor vessel 46. The large ship 30 may be used as a receiving/processing station for low-power transmissions, high-power transmissions, or both. Data included in such transmissions may be embedded into AIS messages and relayed to others according to message 10. In this embodiment, data is collected by one or more deployed/emplaced sensor(s). The sensor(s) may be on any number of platforms or even shore-based. The sensor data is processed by onboard processing hardware (such as the first computer 16 shown in FIG. 1) that is communicatively coupled to the sensor (such as sensor 12 shown in FIG. 1). The processed data is encoded into an AIS message in a suitable type field (e.g. Type 6, 8, 25, 26) with a goal to fit the data into a single slot/sentence for a higher chance of transmission success. The encoding may include encryption and/or forward error correction as well. The data may be broadcast using an AIS transponder on the specified, standard VHF channels. The broadcasted AIS data may be received by one or more of a satellite, a terrestrial AIS receiver, and a ship-based AIS receiver. The AIS messages are decoded when received by the intended user, who pulls out the collected sensor data and converts the sensor data into a standard format. The sensor data may then be transferred to an operator or system for further review and/or processing.

Method 10 may be used to collect and relay those signals not designed for or amenable to long range transmission, such as AIS class-B, low peak power (LPP) radars, and VHF communications, which are hard to receive at long stand-off ranges (e.g. from satellites). The AIS signals, similar to LPP radar signals, are very low power, and the VHF signal propagation is limited to line of sight. As a result, remote reception of these signals can be difficult. For example, satellite collection of AIS signals is more difficult for class-B signals and in dense areas. The huge field of view from a satellite can cause pulse collisions at the satellite receiver. The result is that the detection of these signals from space can be difficult if not impossible in some situations. Method 10 provides a reliable and inexpensive means to collect and transmit data around the world and only requires a sensor to detect signals, an AIS transmitter, and a processor to format and insert the data into the AIS message. Method 10 is capable of distributing the collected data to a larger audience than other communications systems, as there can be several locations receiving and decoding the data in parallel. Further, some embodiments of method 10, such as shown in FIG. 2, can allow a sensor-to-ship data flow without the use of third party data infrastructure (such as satellite communication). The steps of method 10 may be implemented in near-real-time and may use existing satellite and terrestrial AIS networks, which minimizes investment required to implement the method. In some embodiments of method 10, an emplaced, unattended passive sensor 12 can collect and transmit data over the AIS infrastructure without any ties to the originator. For example, an Iridium modem could be linked to an Iridium account or a bespoke communications path might contain information about frequencies and timing, but the users of method 10 are just one of thousands of AIS subscribers.

Depending on the operational scenario, encryption (hardware or software), steganography, or both may be added to allow for sensitive data to be transferred using this method. Using a class-A transmitter to transmit the first AIS transmission 18 would increase the odds that the message is accurately received, but it may be possible to increase the power beyond the AIS specification to ensure message receipt. It is recommended that the first AIS transmission 18 be kept to a single slot/sentence for better communication throughput. Further, the first AIS transmission 18 may be repeated multiple times to improve the odds of receipt. The TDMA slot used for these transmissions may be randomized to mitigate message collisions at the satellite receiver. Repeated transmissions at staggered times may also increase reception likelihood by avoiding pulse collisions. AIS repeaters may be used to extend the reception range of this application. It is even possible to transmit imagery data via the same method by serializing the imagery intensity values and sending via as many AIS messages as necessary to transmit the entire image. As this might not be very efficient for large images, it may only be used in circumstances of very high priority/importance.

From the above description of method 10, it is manifest that various techniques may be used for implementing the concepts of method 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that method 10 is not limited to the particular embodiments described herein, but is capable of many embodiments without departing from the scope of the claims.

We claim:

1. A method for transmitting information comprising:
receiving sensor data from a passive sensor mounted to a first platform;
using a first computer mounted on the first platform to encode the sensor data into a binary code that fits within a message field of an AIS transmission associated with the first platform;
transmitting the AIS transmission that includes the binary code to a second platform;
using a second computer to decode the sensor data from the binary code in the AIS transmission from the first platform; and
displaying the first platform's AIS information along with the decoded sensor data.

2. The method of claim 1, wherein the sensor data is encrypted.

3. The method of claim 2, further comprising decrypting the sensor data with the second computer.

4. The method of claim 1, wherein the binary code is formatted as an AIS field type 6, 8, 25, or 26 message, and wherein the AIS transmission that includes the binary code fits into a single time division multiple access (TDMA) slot/sentence.

5. The method of claim 4, wherein the sensor data is acoustic measurement data that includes an amplitude measured in decibels (dB) along with a time when measured.

6. The method of claim 4, further comprising repeating the same transmission step at staggered time intervals.

7. The method of claim 4, wherein the passive sensor is a camera and the sensor data is an image, and further comprising:
serializing imagery intensity values of the image;
encoding portions of the serialized imagery intensity values into separate binary codes; and
repeating the transmission step for each separate binary code.

8. The method of claim 1, wherein the passive sensor is a sonar sensor.

9. The method of claim 1, wherein the sensor data includes a time, location, pulse length, pulse repetition frequency, and frequency band.

10. The method of claim 1, further comprising using an AIS repeater between the first platform and the second platform.

11. The method of claim 1, wherein the sensor data consists of atmospheric propagation measurements that include a time, location, and signal strength in dB.

12. The method of claim 1, wherein the sensor data is direction finding data that includes a time, location, bearing, range, frequency, amplitude in dB, modulation type, and demodulated meta data.

13. The method of claim 12, wherein the passive sensor is used to determine the range.

14. The method of claim 1, wherein the passive sensor is a VHF receiver and the sensor data is AIS information regarding a given platform.

15. The method of claim 14, wherein the AIS information regarding the given platform was transmitted from the given platform with a class-B AIS transponder.

16. A method for transmitting information comprising:
receiving a given AIS transmission associated with a given platform with a sensor mounted to a first platform;
encoding the given AIS transmission into a binary code that fits within a message field of a first AIS transmission associated with the first platform;
transmitting the first AIS transmission that includes the binary code to a second platform;
decoding the given AIS transmission from the binary code; and
displaying AIS details of both the first and given platforms.

17. The method of claim 16, wherein the second platform is out of range of receiving the given AIS transmission directly from the given platform.

18. The method of claim 17, further comprising sending the given AIS transmission with a class-B AIS transceiver that is mounted to the given platform.

19. The method of claim 18, wherein the AIS details include a unique identification, position, course, and speed for each of the first and given platforms.

20. The method of claim 16, wherein the first platform transmits the first AIS transmission with a class-A transponder.
